(19) United States
(12) Patent Application Publication
(10) Pub. No.: US 2024/0283042 A1
(43) Pub. Date: Aug. 22, 2024

(54) ALL SOLID BATTERY AND EVALUATION METHOD OF THE SAME

(71) Applicant: TAIYO YUDEN CO., LTD., Tokyo (JP)

(72) Inventors: Ryoichi WATABE, Tokyo (JP); Chie KAWAMURA, Tokyo (JP)

(73) Assignee: TAIYO YUDEN CO., LTD., Tokyo (JP)

(21) Appl. No.: 18/689,283

(22) PCT Filed: Aug. 12, 2022
(86) PCT No.: PCT/JP2022/030820

§ 371 Date: Mar. 5, 2024

(30) Foreign Application Priority Data
Sep. 30, 2021 (JP) 2021-161138

(51) Int. Cl. H01M 10/48; H01M 10/0585; H01M 10/44; H02J 7/00

(52) U.S. Cl. CPC H01M 10/48; H01M 10/0585; H01M 10/44; H01M 2300/0065; H02J 7/0047

(57) ABSTRACT

An all solid battery includes a solid electrolyte layer, a first electrode layer that is provided on a first main face of the solid electrolyte layer and includes an electrode active material, and a second electrode layer that is provided on a second main face of the solid electrode layer and includes an electrode active material. when the all solid battery is heated with an increase rate of 20° C./min, CO₂ of 30 mg/cm³ or more and 53 mg/cm³ or less is externally generated from the all solid battery from 550° C. to 700° C. and CO₂ of 90 mg/cm³ or more and 155 mg/cm³ or less is externally generated from the all solid battery from 550° C. to 750° C., per a unit volume (cm³) of the all solid battery.

### TECHNICAL FIELD

The present invention relates to an all solid battery and an evaluation method of the all solid battery.

### BACKGROUND ART

All solid batteries using oxide-based solid electrolytes are expected to be a technology that can provide safe secondary batteries that do not cause ignition or toxic gas generation, which are concerns with organic electrolytes, sulfide-based solid electrolytes, or the like. Since such all solid batteries are small components, a technique for efficiently detecting initial defects is required.

### PRIOR ART DOCUMENT

### Patent Document

Patent Document 1: International Publication No. 2018/026009

### DISCLOSURE OF THE INVENTION

### Problems to be Solved by the Invention

Therefore, in order to detect initial failures such as minute cracks, structural defects, and internal cracks that cannot be detected visually, it is conceivable to detect the gas generated from the all solid battery by heating. For example, Patent Document 1 discloses a technique for impregnating an all solid battery with moisture, so it is conceivable to use this technique to detect moisture leaking as the temperature rises. However, if the all solid battery contains moisture, there is a risk that certain components in the all solid battery will be eluted. Therefore, it is conceivable to use another gas. However, if a large amount of gas is contained in an all solid battery, there is a risk that a short circuit will occur.

The present invention has been made in view of the above problems, and aims to provide an all solid battery and an evaluation method thereof that can detect initial failure while suppressing the occurrence of short circuits.

### Means for Solving the Problems

An all solid battery of the present invention includes a solid electrolyte layer; a first electrode layer that is provided on a first main face of the solid electrolyte layer and includes an electrode active material; and a second electrode layer that is provided on a second main face of the solid electrode layer and includes an electrode active material, characterized in that when the all solid battery is heated with an increase rate of 20° C./min, CO₂ of 30 mg/cm³ or more and 53 mg/cm³ or less is externally generated from the all solid battery from 550° C. to 700° C. and CO₂ of 90 mg/cm³ or more and 155 mg/cm³ or less is externally generated from the all solid battery from 550° C. to 750° C., per a unit volume (cm³) of the all solid battery.

In the above-mentioned all solid battery, the solid electrolyte layer may have a cavity including CO₂ inside thereof.

In the above-mentioned all solid battery, a thickness of the solid electrolyte layer may be 5 μm or more and 30 μm or less.

An evaluation method of an all solid battery is characterized by including:

evaluating the all solid battery by detecting CO₂ externally generated from the all solid battery when performing charging and discharging of the all solid battery as claimed in any of claims 1 to 3.

### Effects of the Invention

According to the present invention, it is possible to provide an all solid battery, a method for manufacturing an all solid-state battery, and an evaluation method thereof that can detect initial defects while suppressing the occurrence of short circuits.

### BRIEF DESCRIPTION OF THE DRAWINGS

FIG. 1 is a schematic cross-sectional view illustrating a basic structure of an all solid battery;

FIG. 2 illustrates a schematic cross section of an all solid battery of an embodiment;

FIG. 3 illustrates a schematic cross section of another all solid battery;

FIG. 4 is a diagram illustrating an amount of CO₂ generated externally from an all solid battery when the temperature increase rate is 20° C./min;

FIG. 5 is a diagram illustrating a SEM image of a cross section of a solid electrolyte layer;

FIG. 6 illustrates a flowchart of a manufacturing method of an all solid battery;

FIG. 7A and FIG. 7B illustrate a stacking process;

### BEST MODES FOR CARRYING OUT THE INVENTION

A description will be given of an embodiment with reference to the accompanying drawings.

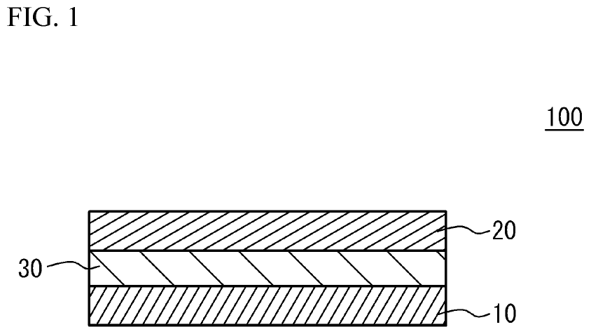

(Embodiment) FIG. 1 is a schematic cross-sectional view illustrating the basic structure of an all solid battery 100. As illustrated in FIG. 1, the all solid battery 100 has a structure in which a solid electrolyte layer 30 is sandwiched between a first internal electrode 10 (first electrode layer) and a second internal electrode 20 (second electrode layer). The first internal electrode 10 is formed on a first main face of the solid electrolyte layer 30. The second internal electrode 20 is formed on the second main face of the solid electrolyte layer 30.

When the all solid battery 100 is used as a secondary battery, one of the first internal electrode 10 and the second internal electrode 20 is used as a positive electrode, and the other is used as a negative electrode. In this embodiment, as an example, the first internal electrode 10 is used as a positive electrode, and the second internal electrode 20 is used as a negative electrode.

The solid electrolyte layer 30 has an oxide-based solid electrolyte having a NASICON structure and having ionic conductivity as a main component. The solid electrolyte of the solid electrolyte layer 30 is, for example, an oxide-based solid electrolyte having lithium ion conductivity. The solid electrolyte is, for example, a phosphate solid electrolyte. The phosphoric acid salt-based solid electrolyte having the NASICON structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like. For example, a Li—Al—Ge—PO₄-based material to which the same transition metal as that contained in the phosphate having an olivine crystal structure contained in the first internal electrode 10 and the second internal electrode 20 is added in advance is preferable. For example, when the first internal electrode 10 and the second internal electrode 20 contain a phosphate containing Co and Li, it is preferable that a Li—Al—Ge—PO₄ material to which Co has been added is used in the solid electrolyte layer 30. In this case, the effect of suppressing elution of the transition metal contained in the electrode active material into the electrolyte can be obtained. When the first internal electrode 10 and the second internal electrode 20 contain a phosphate containing a transition element other than Co and Li, it is preferable that the Li—Al—Ge—PO₄-based material to which the transition metal is added in advance is included in the electrolyte layer 30.

The first internal electrode 10 used as a positive electrode includes a material having an olivine type crystal structure, as an electrode active material. It is preferable that the second internal electrode 20 also includes the electrode active material. The electrode active material is such as phosphoric acid salt including a transition metal and lithium. The olivine type crystal structure is a crystal of natural olivine. It is possible to identify the olivine type crystal structure, by using X-ray diffraction.

For example, LiCoPO₄ including Co may be used as a typical example of the electrode active material having the olivine type crystal structure. Other salts of phosphoric acid, in which Co acting as a transition metal is replaced to another transition metal in the above-mentioned chemical formula, may be used. A ratio of Li or PO₄ may fluctuate in accordance with a valence. It is preferable that Co, Mn, Fe, Ni or the like is used as the transition metal.

The electrode active material having the olivine type crystal structure acts as a positive electrode active material in the first internal electrode 10 acting as a positive electrode. For example, when only the first internal electrode 10 includes the electrode active material having the olivine type crystal structure, the electrode active material acts as the positive electrode active material. When the second internal electrode 20 also includes an electrode active material having the olivine type crystal structure, discharge capacity may increase and an operation voltage may increase because of electric discharge, in the second internal electrode 20 acting as a negative electrode. The function mechanism is not completely clear. However, the mechanism may be caused by partial solid-phase formation together with the negative electrode active material.

When both the first internal electrode 10 and the second internal electrode 20 include an electrode active material having the olivine type crystal structure, the electrode active material of each of the first internal electrode 10 and the second internal electrode 20 may have a common transition metal. Alternatively, the a transition metal of the electrode active material of the first internal electrode 10 may be different from that of the second internal electrode 20. The first internal electrode 10 and the second internal electrode 20 may have only single type of transition metal. The first internal electrode 10 and the second internal electrode 20 may have two or more types of transition metal. It is preferable that the first internal electrode 10 and the second internal electrode 20 have a common transition metal. It is more preferable that the electrode active materials of the both electrode layers have the same chemical composition. When the first internal electrode 10 and the second internal electrode 20 have a common transition metal or a common electrode active material of the same composition, similarity between the compositions of the both electrode layers increases. Therefore, even if terminals of the all solid battery 100 are connected in a positive/negative reversed state, the all solid battery 100 can be actually used without malfunction, in accordance with the usage purpose.

The second internal electrode 20 may include known material as the negative electrode active material. When only one of the electrode layers includes the negative electrode active material, it is clarified that the one of the electrode layers acts as a negative electrode and the other acts as a positive electrode. When only one of the electrode layers includes the negative electrode active material, it is preferable that the one of the electrode layers is the second internal electrode 20. Both of the electrode layers may include the known material as the negative electrode active material. Conventional technology of secondary batteries may be applied to the negative electrode active material. For example, titanium oxide, lithium-titanium complex oxide, lithium-titanium complex salt of phosphoric acid salt, a carbon, a vanadium lithium phosphate.

In the forming process of the first internal electrode 10 and the second internal electrode 20, moreover, oxide-based solid electrolyte material or a conductive material (conductive auxiliary agent) such as a carbon material or a metal material may be added. When the material is evenly dispersed into water or organic solution together with binder or plasticizer, paste for electrode layer is obtained. In the embodiment, a carbon material is used as the conductive auxiliary agent. A metal material may be used as the auxiliary agent, in addition to the carbon material. Pd, Ni, Cu, or Fe, or an alloy thereof may be used as the metal material of the conductive auxiliary agent. For example, the electrolyte of the first internal electrode 10 and the second internal electrode 20 may be the same as the main component solid electrolyte of the solid electrolyte layer 30.

The thickness of the solid electrolyte layer 30 is, for example, 5 μm or more and 30 μm or less, 7 μm or more and 25 μm or less, and 10 μm or more and 20 μm or less. The thickness of the first internal electrode 10 and the second internal electrode 20 is, for example, 5 μm or more and 50 μm or less, 7 μm or more and 45 μm or less, and 10 μm or more and 40 μm or less. The thickness of each layer can be measured, for example, as the average value of the thicknesses at 10 different points of one layer.

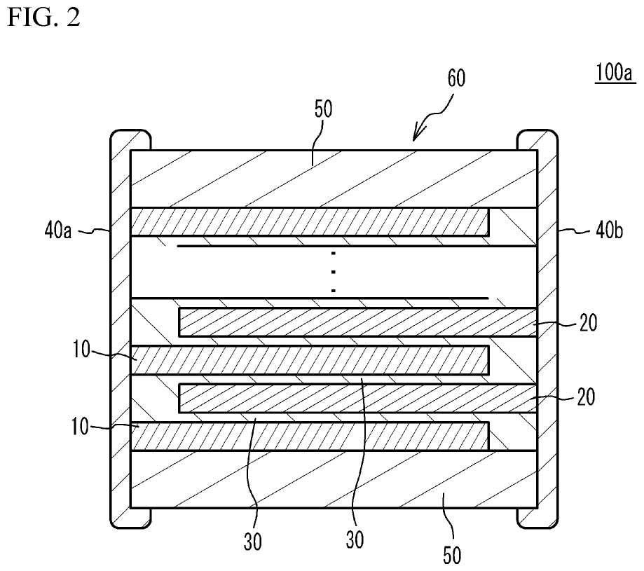

FIG. 2 illustrates a schematic cross section of an all solid battery 100a in which a plurality of cell units are stacked. The all solid battery 100a has a multilayer chip 60 having a rectangular parallelepiped shape. Each of a first external electrode 40a and a second external electrode 40b is provided directly on each of two side faces among four side faces which are other than an upper face and a lower face of the multilayer chip 60 in the stacking direction. The two side faces may be adjacent to each other. Alternatively, the two side faces may be face with each other. In the embodiment, the first external electrode 40a and the second external electrode 40b are provided so as to contact two side faces facing each other (hereinafter referred to as two edge faces).

In the following description, the same numeral is added to each member that has the same composition range, the same thickness range and the same particle distribution range as that of the all solid battery 100. And, a detail explanation of the same member is omitted.

In the all solid battery 100a, each of the first internal electrodes 10 and each of the second internal electrodes 20 sandwich each of the solid electrolyte layer 30 and are alternately stacked. Edges of the first internal electrodes 10 are exposed to the first edge face of the multilayer chip 60 but are not exposed to the second edge face of the multilayer chip 60. Edges of the second internal electrodes 20 are exposed to the second edge face of the multilayer chip 60 but are not exposed to the first edge face. Thus, each of the first internal electrodes 10 and each of the second internal electrodes 20 are alternately conducted to the first external electrode 40a and the second external electrode 40b. The solid electrolyte layer 30 extends from the first external electrode 40a to the second external electrode 40b. In this way, the all solid battery 100a has a structure in which a plurality of cell units are stacked.

A cover layer 50 is stacked on an upper face (in FIG. 2 on the upper face of the uppermost internal electrode) of a stacked structure of the first internal electrode 10, the solid electrolyte layer 30 and the second internal electrode 20. Another cover layer 50 is stacked on a lower face (in FIG. 2, on the lower face of the lowermost internal electrode) of the stacked structure. A main component of the cover layer 50 is an inorganic material such as Al, Zr, Ti (for example, Al₂O₃, ZrO₂, TiO₂ or the like). The main component of the cover layer 50 may be the main component of the solid electrolyte layer 30.

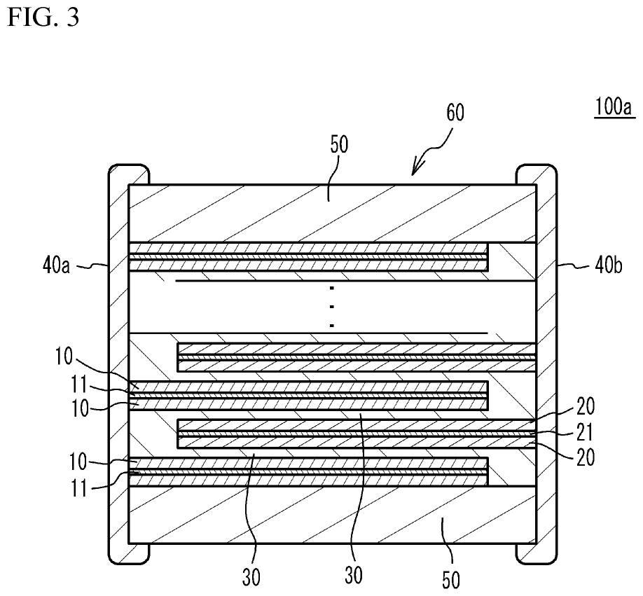

The first internal electrode 10 and the second internal electrode 20 may have an electric collector layer. For example, as illustrated in FIG. 3 a first electric collector layer 11 may be provided in the first internal electrode 10. A second electric collector layer 21 may be provided in the second internal electrode 20. A main component of the first electric collector layer 11 and the second electric collector layer 21 is a conductive material. For example, the conductive material of the first electric collector layer 11 and the second electric collector layer 21 may be such as a metal, carbon or the like. When the first electric collector layer 11 is connected to the first external electrode 40a and the second electric collector layer 21 is connected to the second external electrode 40b, current collecting efficiency is improved.

Since all solid batteries are generally small components, technology to efficiently detect initial failures is required. Initial defects include minute cracks, structural defects, and internal cracks that cannot be detected externally. When a charge/discharge test is performed on an all solid battery that has an initial failure and contains gas components inside, the gas components will be generated (leak) from the all solid battery to the outside. Therefore, by determining whether the gas component is detected or not when performing a charge/discharge test on the all solid battery, it becomes possible to determine whether or not the all solid battery has an initial failure.

Therefore, for example, it is possible to include a predetermined amount of moisture inside the all solid battery and detect the moisture generated outside the all solid battery by heating. However, if the all solid battery contains moisture, there is a risk that certain components in the all solid battery will be eluted into the moisture. Therefore, in this embodiment, CO₂ is focused on (carbon dioxide).

In the present embodiment, the all solid battery 100a is made to contain CO₂ gas by making the voids inside the solid electrolyte layer 30 contain CO₂ gas. With this structure, if the all solid battery 100a has an initial failure such as a minute crack, a structural defect, or an internal crack that cannot be detected externally, the all solid battery 100a can be subjected to a charge/discharge test. As the temperature rises, CO₂ is generated outside from the all solid battery 100a. Therefore, by conducting a charge/discharge test and determining whether CO₂ is detected or not, it is possible to determine whether or not the all solid battery 100a has an initial failure.

However, if the amount of CO₂ contained in the all solid battery 100a is small, even if an initial failure occurs, there is a possibility that CO₂ generation cannot be detected during the charge/discharge test. Therefore, it is preferable to set a lower limit on the amount of CO₂ contained in the all solid battery 100a. Since it is difficult to measure the amount of CO₂ contained in the all solid battery 100a at room temperature, it is defined by the amount of CO₂ generated outside the all solid battery 100a when the all solid battery 100a is heated.

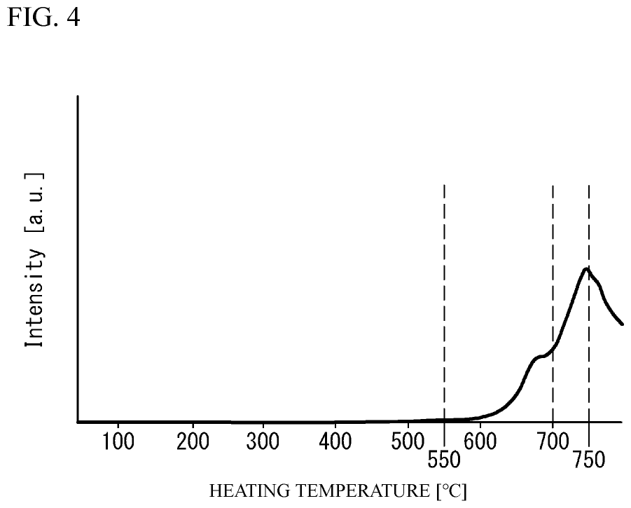

FIG. 4 is a diagram illustrating the amount of CO₂ generated externally from the all solid battery 100a when the temperature increase rate is 20° C./min. As illustrated in FIG. 4, as the all solid battery 100a is heated, CO₂ is generated when the temperature exceeds 550° C., the rate of increase decreases when the temperature exceeds 650° C., and when the temperature exceeds 700° C., the amount of CO₂ generated tends to increase rapidly up to about 750° C. The reason why the amount of CO₂ generated increases from over 700° C. to about 750° C. is considered to be because CO₂ is emitted as the solid electrolyte crystallizes.

Therefore, in this embodiment, when the temperature increase rate is 20° C./min, the amount of CO₂ contained in the all-solid-state battery 100a is defined in two stages of the amount of CO₂ generated from 550° C. to 700° C. and the amount of CO₂ generated from 550° C. to 750° C. Specifically, CO₂ is contained in the all solid battery 100a so that when the all solid battery 100a is heated, CO₂ of 30 mg/cm³ or more is generated from 550° C. to 700° C., and CO₂ of 90 mg/cm³ or more is generated from 550° C. to 750° C. From the perspective of more reliably detecting CO₂ generation during charge/discharge tests, it is preferable that 60 mg/cm³ or more of CO₂ is generated from 550° C. to 700° C., and 160 mg/cm³ or more of CO₂ is generated from 550° C. to 750° C. It is more preferable that 80 mg/cm³ or more of CO₂ is generated from 550° C. to 700° C., and 200 mg/cm³ or more of CO₂ is generated from 550° C. to 750° C.

Note that “mg/cm³” of the amount of CO₂ generated above means the amount of CO₂ generated (mg) per unit volume (cm³) of the all solid battery 100a.

On the other hand, if the amount of CO₂ contained in the all solid battery 100a is large, there is a risk that a short circuit will occur because the insulation resistance of the solid electrolyte decreases. Therefore, it is preferable to set an upper limit on the amount of CO₂ contained in the all solid battery 100a. Specifically, CO₂ is contained in the all solid battery 100a so that when the all solid battery 100a is heated, CO₂ of 53 mg/cm³ or less is generated from 550° C. to 700° C., and CO₂ of 155 mg/cm³ or less is generated from 550° C. to 750° C. From the viewpoint of further suppressing the occurrence of short circuits, it is preferable that 40 mg/cm³ or less of CO₂ is generated from 550° C. to 700° C., and that 80 mg/cm³ or less of CO₂ is generated from 550° C. to 750° C. It is more preferable that 20 mg/cm³ or less of CO₂ is generated from 550° C. to 700° C., and 50 mg/cm³ or less of CO₂ is generated from 550° C. to 750° C.

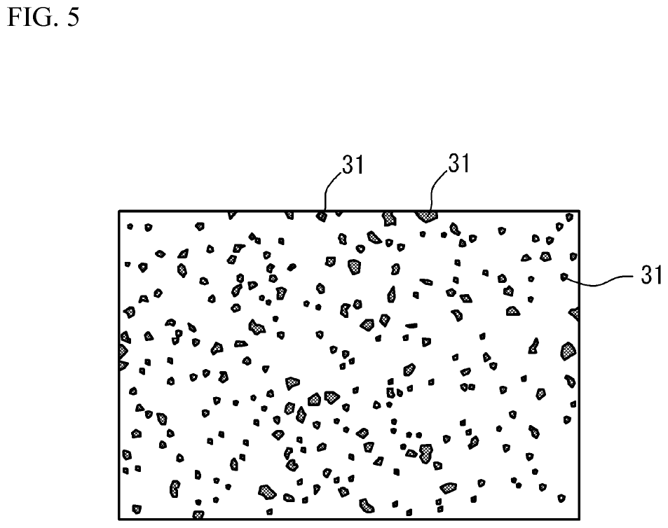

For example, a plurality of voids are formed in the solid electrolyte layer 30, and CO₂ is contained in the voids. FIG. 5 is a diagram illustrating a SEM image of a cross section of the solid electrolyte layer 30. The cross section is, for example, a cross section along the stacking direction of the first internal electrode 10, the solid electrolyte layer 30, and the second internal electrode 20. As illustrated in FIG. 5, a plurality of voids 31 are formed in the solid electrolyte layer 30. Further, each of the voids 31 is made to contain CO₂.

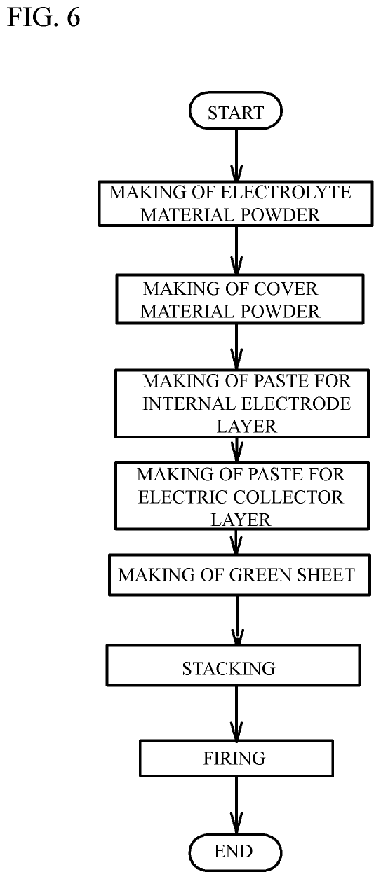

A description will be given of a manufacturing method of the all solid battery 100a. FIG. 6 illustrates a flowchart of the manufacturing method of the all solid battery 100a.

(Making process of ceramic material powder) Raw material powder for solid electrolyte layer forming the solid electrolyte layer 30 is made. For example, it is possible to make the solid electrolyte powder, by mixing raw material and additives and using solid phase synthesis method or the like. The resulting powder is subjected to grinding with organic solvent. Thus, a particle diameter of the resulting power is adjusted to a desired one. For example, it is possible to adjust the particle diameter to the desired diameter with use of planetary ball mill using ZrO₂ ball of 5 mm q. By pulverizing in the presence of an organic solvent, organic groups with O (oxygen) interposed therein, such as ethoxy groups and propyl groups, are chemically bonded to dangling bonds on the surface of the raw material powder. The organic group with O (oxygen) interposed therein is, for example, an alkoxy group expressed by an RO bond (R is an alkyl group, or the like).

(Making process of raw material powder for cover layer) First, a ceramics raw material powder that constitutes the cover layer 50 described above is prepared. For example, raw material powder for the cover layer can be made by mixing raw materials, additives and so on and using a solid-phase synthesis method or the like. By dry pulverizing the obtained raw material powder, it is possible to adjust to a desired average particle size. For example, a planetary ball mill using ZrO₂ balls of 5 mmϕ is used to adjust the desired average particle size. When the solid electrolyte layer 30 and the cover layer 50 have the same composition, the raw material powder for solid electrolyte layer can be used as the raw material powder for cover layer.

(Making process for internal electrode) Next, an internal electrode paste for forming the above-described first internal electrode 10 and the second internal electrode 20 is made. For example, an internal electrode paste can be obtained by uniformly dispersing a conductive aid, an electrode active material, a solid electrolyte material, a sintering aid, a binder, a plasticizer, and so on in water or an organic solvent. As the solid electrolyte material, the solid electrolyte paste described above may be used. A carbon material or the like is used as the conductive aid. A metal may be used as the conductive aid. Examples of the metal of the conductive aid include Pd, Ni, Cu, Fe, and alloys containing these. Pd, Ni, Cu, Fe, alloys containing these, and various carbon materials may also be used. When the compositions of the first internal electrode 10 and the second internal electrode 20 are different from each other, the respective internal electrode pastes may be prepared separately.

As the sintering aid, for example, any glass component such as Li—B—O based compounds, Li—Si—O based compounds, Li—C—O based compounds, Li—S—O based compounds, and Li—P—O based compounds can be used.

(External electrode paste preparation process) Next, an external electrode paste for forming the first external electrode 40a and the second external electrode 40b is made. For example, an external electrode paste can be obtained by uniformly dispersing a conductive material, a glass frit, a binder, a plasticizer, and the like in water or an organic solvent.

(Forming process of green sheet) A solid electrolyte slurry having a desired average particle size is prepared by uniformly dispersing the raw material powder for the solid electrolyte layer in an aqueous solvent or an organic solvent together with a binder, a dispersant, a plasticizer, and so on followed by wet pulverization. At this time, a bead mill, a wet jet mill, various kneaders, a high-pressure homogenizer, or the like can be used. And it is preferable to use a bead mill from the viewpoint of being able to simultaneously adjust the particle size distribution and disperse. A binder is added to the obtained solid electrolyte slurry to obtain a solid electrolyte paste. By applying the obtained solid electrolyte paste, the solid electrolyte green sheet 51 can be formed. The applying method is not particularly limited. A slot die method, a reverse coating method, a gravure coating method, a bar coating method, a doctor blade method, or the like can be used. The particle size distribution after wet pulverization can be measured, for example, using a laser diffraction measurement device using a laser diffraction scattering method.

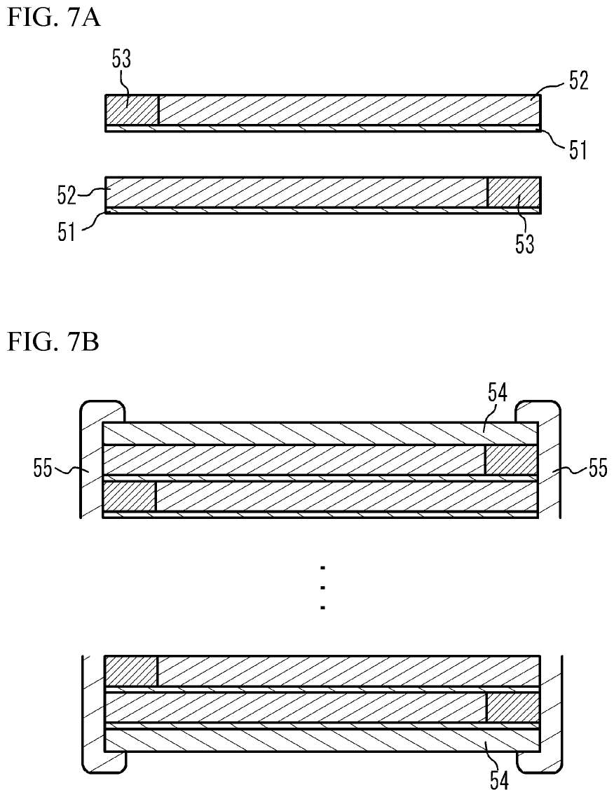

(Stacking process) Paste 52 for internal electrode is printed on one face of the solid electrolyte green sheet 51, as illustrated in FIG. 7A. A thickness of the paste 52 for internal electrode is equal to or more than a thickness of the solid electrolyte green sheet 51. A reverse pattern 53 is printed on a part of the solid electrolyte green sheet 51 where the paste 52 for electrode layer is not printed. A material of the reverse pattern 53 may be the same as that of the solid electrolyte green sheet 51. The solid electrolyte green sheets 51 after printing are stacked so that each of the solid electrolyte green sheets 51 is alternately shifted to each other. As illustrated in FIG. 7B, cover sheets 54 are clamped from an upper side and a lower side of the stacking direction. Thus, a multilayer structure is obtained. In this case, in the multilayer structure, each of the paste 52 for internal electrode is alternately exposed to the two end faces. The cover sheet 54 is formed by printing the material powder for cover layer with the same method as the forming of the solid electrolyte green sheet. The thickness of the cover sheet 54 is larger than the thickness of the solid electrolyte green sheet 51. The cover sheet 54 may be thickened during printing of the cover sheet 54. The cover sheet 54 may be thickened by stacking t plurality of the printed sheets.

Next, the two end faces are coated with paste 55 for external electrode by dipping method or the like. After that, the paste 55 for external electrode is dried. Thus, a compact for forming the all solid battery 100a is obtained.

(Firing process) Next, the obtained multilayer structure is fired. The firing conditions are oxidizing atmosphere or non-oxidizing atmosphere, and the maximum temperature is preferably 400° C. to 1000° C., more preferably 500° C. to 900° C., without any particular limitation. A step of holding below the maximum temperature in an oxidizing atmosphere may be provided to sufficiently remove the binder until the maximum temperature is reached. In order to reduce process costs, it is desirable to perform the firing at as low a temperature as possible. After firing, re-oxidation process may be performed. Through the above steps, the all solid battery 100a is produced.

The internal electrode paste, a current collector paste containing the conductive material, and the internal electrode paste may be sequentially stacked to form current collector layers in the first internal electrode 10 and the second internal electrode 20.

In the manufacturing method according to this embodiment, an organic group with O (oxygen) interposed therein, such as an ethoxy group or a propyl group, is chemically bonded to the surface of the raw material powder for the solid electrolyte layer. Since organic groups with O (oxygen) interposed therebetween are stably bonded, they tend to remain without being desorbed even when the raw material powder starts sintering and densification. The organic group containing O (oxygen) is desorbed and gasified after the ambient temperature exceeds the sintering start temperature in the firing process. In this case, since the solid electrolyte is dense around the organic group with O (oxygen) interposed therebetween, the gas is not discharged to the outside and becomes spheroidal. The spheroidized portion of this gas forms the void 31. The gasified organic group containing O (oxygen) is oxidized to become CO₂.

For example, the amount of CO₂ contained in the solid electrolyte layer 30 can be adjusted by adjusting firing conditions such as the average particle size of the raw material powder for the solid electrolyte layer, the firing temperature in the firing process, and the firing time in the firing process.

Note that the method for including CO₂ in the solid electrolyte layer 30 is not limited to the above. For example, CO₂ can be included in the solid electrolyte layer 30 by heating the all solid battery 100a in an atmosphere containing a large amount of CO₂ gas. As an example, the solid electrolyte layer 30 can contain CO₂ by heating to about 700° C. in an atmosphere of 90% N₂ gas and 10% CO₂ gas. Thereafter, the amount of CO₂ in the solid electrolyte layer 30 can be adjusted by heating in a reduced pressure atmosphere to generate CO₂ from the solid electrolyte layer 30.

### EXAMPLES

An all solid battery having the structure illustrated in FIG. 2 and including 170 solid electrolyte layers was fabricated. The shape of the all solid battery was 4.5 mm×3.2 mm×3.2 mm.

(Example 1) In Example 1, CO₂ gas was included in the solid electrolyte layer by heating each sample to 700° C. in an atmosphere containing 90% by volume of N₂ gas and 10% by volume of CO₂ gas. Thereafter, the amount of CO₂ gas in the solid electrolyte layer was adjusted by heating to 700° C. in an electric furnace with a pressure controlled to 103 Pa.

(Example 2) In Example 2, each sample was heated to 700° C. in an atmosphere containing 90% by volume of N₂ gas and 10% by volume of CO₂ gas, so that CO₂ gas was included in the solid electrolyte layer. Thereafter, the amount of CO₂ gas in the solid electrolyte layer was adjusted by heating to 700° C. in an electric furnace with a pressure controlled to 104 Pa. By making the pressure in the electric furnace higher than that in Example 1, the amount of CO₂ gas remaining in the solid electrolyte layer was increased.

(Example 3) In Example 3, each sample was heated to 700° C. in an atmosphere containing 90% by volume of N₂ gas and 10% by volume of CO₂ gas, so that CO₂ gas was included in the solid electrolyte layer. Thereafter, the amount of CO₂ gas in the solid electrolyte layer was adjusted by heating to 600° C. in an electric furnace with a pressure controlled to 104 Pa. By lowering the temperature inside the electric furnace than that in Example 2, the amount of CO₂ gas remaining in the solid electrolyte layer was increased.

(Comparative example 1) In Comparative Example 1, CO₂ gas was included in the solid electrolyte layer by heating each sample to 700° C. in an atmosphere containing 90% by volume of N₂ gas and 10% by volume of CO₂ gas. Thereafter, the amount of CO₂ gas in the solid electrolyte layer was adjusted by heating to 700° C. in an electric furnace with a pressure controlled to 102 Pa. By lowering the pressure in the electric furnace than in Example 1, the amount of CO₂ gas remaining in the solid electrolyte layer was reduced.

(Comparative example 2) In Comparative Example 2, CO₂ gas was included in the solid electrolyte layer by heating each sample to 700° C. in an atmosphere containing 90% by volume of N₂ gas and 10% by volume of CO₂ gas. Thereafter, the amount of CO₂ gas in the solid electrolyte layer was adjusted by heating it to 600° C. in an air atmosphere. By heating under a higher pressure than that in Example 3, the amount of CO₂ gas remaining in the solid electrolyte layer was increased.

(Comparative example 3) In Comparative Example 3, CO₂ gas was included in the solid electrolyte layer by heating each sample to 700° C. in an atmosphere containing 90% by volume of N₂ gas and 10% by volume of CO₂ gas. By not adjusting the amount of CO₂ gas in the solid electrolyte layer, the amount of CO₂ gas remaining in the solid electrolyte layer was increased compared to Comparative Example 2.

For each of Examples 1 to 3 and Comparative Examples 1 to 3, the amount of CO₂ (mg/cm³) generated from 550° C. to 700° C. when heated at a temperature increase rate of 20° C./min, and the amount of CO₂ generated from 550° C. to 750° C. when heated at a temperature increase rate of 20° C./min were measured. The amount of CO₂ (mg/cm³) generated up to this point was measured. In Example 1, the amount of CO₂ generated from 550° C. to 700° C. was 30 mg/cm³, and the amount of CO₂ generated from 550° C. to 750° C. was 90 mg/cm³. In Example 2, the amount of CO₂ generated from 550° C. to 700° C. was 45 mg/cm³, and the amount of CO₂ generated from 550° C. to 750° C. was 125 mg/cm³. In Example 3, the amount of CO₂ generated from 550° C. to 700° C. was 53 mg/cm³, and the amount of CO₂ generated from 550° C. to 750° C. was 155 mg/cm³. In Comparative Example 1, the amount of CO₂ generated from 550° C. to 700° C. was 15 mg/cm³, and the amount of CO₂ generated from 550° C. to 750° C. was 45 mg/cm³. In Comparative Example 2, the amount of CO₂ generated from 550° C. to 700° C. was 60 mg/cm³, and the amount of CO₂ generated from 550° C. to 750° C. was 185 mg/cm³. In Comparative Example 3, the amount of CO₂ generated from 550° C. to 700° C. was 75 mg/cm³, and the amount of CO₂ generated from 550° C. to 750° C. was 215 mg/cm³. Gas chromatography was used to measure the amount of CO₂.

100 samples of each of Examples 1 to 3 and Comparative Examples 1 to 3 were examined to see if short circuits occurred. The short rate (%) was calculated by calculating the number of shorts in 100 samples. The results are shown in Table 1. For Examples 1 to 3 and Comparative Examples 1 to 3, if the short rate is 10% or less, it is judged as passing “o”. If the short rate is 15% or less, it is judged as fair “A”. If the short rate exceeds 15%, it is judged as failing “x”. In Examples 1 to 3 and Comparative Example 1, it is judged as passing “o”, and in Comparative Examples 2 and 3, it is judged as failing “x”. It is thought that this is because in Examples 1 to 3 and Comparative Example 1, the amount of CO₂ generated from 550° C. to 700° C. was 53 mg/cm³ or less, and the amount of CO₂ generated from 550° C. to 750° C. was 155 mg/cm³ or less.

TABLE 1

| | | | | | DE- | OVER- |
|---|---|---|---|---|---|---|
| | AMOUNT OF | | | | TEC- | ALL |
| | CO₂ (mg/cm³) | | SHORT | | TION | EVAL- |
| | 550° C.~ | 550° C.~ | RATE | | OF CO₂ | UA- |
| | 700° C. | 750° C. | (%) | JUDGE | JUDGE | TION |
| EXAMPLE 1 | 30 | 90 | 4 | ○ | ○ | ○ |
| EXAMPLE 2 | 45 | 125 | 7 | ○ | ○ | ○ |
| EXAMPLE 3 | 53 | 155 | 10 | ○ | ○ | ○ |
| COMPARATIVE | 15 | 45 | 3 | ○ | x | x |
| EXAMPLE 1 | | | | | | |
| COMPARATIVE | 60 | 185 | 17 | x | ○ | × |
| EXAMPLE 2 | | | | | | |
| COMPARATIVE | 75 | 215 | 40 | x | ○ | × |
| EXAMPLE 3 | | | | | | |

For each of Examples 1 to 3 and Comparative Examples 1 to 3, a notch was made to create an initial failure state, and then charging and discharging was performed, and it was determined whether CO₂ could be detected by a CO₂ detector during charging and discharging. As a CO₂ detector, a carbon dioxide concentration meter CD-1000 manufactured by GASTEC was used. For Examples 1 to 3 and Comparative Examples 1 to 3, if CO₂ was detected, it was judged as passing “o”, and if CO₂ was not detected, it was judged as failing “x”. Table 1 shows the results. Examples 1 to 3 and Comparative Examples 2 and 3 were judged as passing “o”, and Comparative Example 1 was judged as failing “x”. This is because that in Examples 1 to 3 and Comparative Examples 2 and 3, the amount of CO₂ generated from 550° C. to 700° C. was 30 mg/cm³ or more, and the amount of CO₂ generated from 550° C. to 750° C. was 90 mg/cm³ or more.

For Examples 1 to 3 and Comparative Examples 1 to 3, if neither the short rate nor the CO₂ detection was judged as failing “x”, the overall evaluation was judged as passing “o”. If at least one of the short rate and CO₂ detection was judged as failing “x”, the overall judgment was judged as failing “x”. Table 1 shows the results. In Comparative Examples 1 to 3, the results were all failing “x”, whereas in Examples 1 to 3, the results were all passing “o”. This is because that in Examples 1 to 3, the amount of CO₂ generated from 550° C. to 700° C. was 53 mg/cm³ or less, the amount of CO₂ generated from 550° C. to 750° C. was 155 mg/cm³ or less, the amount of CO₂ generated from 550° C. to 700° C. was 30 mg/cm³ or more, the amount of CO₂ generated from 550° C. to 750° C. was 90 mg/cm³ or more.

Although the embodiments of the present invention have been described in detail, it is to be understood that the various change, substitutions, and alterations could be made hereto without departing from the spirit and scope of the invention.

1. An all solid battery comprising:
a solid electrolyte layer;
a first electrode layer that is provided on a first main face of the solid electrolyte layer and includes an electrode active material; and
a second electrode layer that is provided on a second main face of the solid electrode layer and includes an electrode active material,
wherein when the all solid battery is heated with an increase rate of 20° C./min, CO₂ of 30 mg/cm³ or more and 53 mg/cm³ or less is externally generated from the all solid battery from 550° C. to 700° C. and CO₂ of 90 mg/cm³ or more and 155 mg/cm³ or less is externally generated from the all solid battery from 550° C. to 750° C., per a unit volume (cm³) of the all solid battery.

2. The all solid battery as claimed in claim 1, wherein the solid electrolyte layer has a cavity including CO₂ inside thereof.

3. The all solid battery as claimed in claim 1, wherein a thickness of the solid electrolyte layer is 5 μm or more and 30 μm or less.

4. An evaluation method of an all solid battery comprising:
evaluating the all solid battery by detecting CO₂ externally generated from the all solid battery when performing charging and discharging of the all solid battery as claimed in claim 1.
